(19) United States
(12) Patent Application Publication
(10) Pub. No.: US 2007/0237069 A1
(43) Pub. Date: Oct. 11, 2007

(54) Multi-Step Channel Prediction Apparatus and Method for Adaptive Transmission in OFDM/FDD System

(76) Inventors: Kyung Hi Chang, Seoul (KR); Joo Heo, Incheon (KR)

Correspondence Address: MORGAN LEWIS & BOCKIUS LLP, 1111 PENNSYLVANIA AVENUE NW, WASHINGTON, DC, 20004, US

(21) Appl. No.: 11/674,063

(22) Filed: Feb. 12, 2007

(30) Foreign Application Priority Data
Mar. 30, 2006 (KR) 10-2006-0029148

(51) Int. Cl. H04J 11/00

(52) U.S. Cl. 370/208; 370/252

(57) ABSTRACT

Provided are a multi-step channel prediction apparatus and method for adaptive transmission in an OFDM/FDD system. A channel prediction is preformed considering a time-varying characteristic of a channel changing within one slot, in addition to feedback and processing delay time between a transmitter and a receiver, and an adaptive transmission is performed. Therefore, a target PER performance can be maintained without degradation of the system performance. The channel prediction apparatus includes: a primary channel prediction unit for predicting a channel to be generated before an L^{th} OFDM symbol from an output of a channel estimation unit; a secondary channel prediction unit for predicting a channel to be generated before a 2L^{th} OFDM symbol, based on a channel value predicted by the primary channel prediction unit and a measured channel value that is a reception channel value previously checked by a mobile station; and a channel information determination unit for determining if a channel characteristic during one slot period is monotone decreasing or monotone increasing, based on the outputs of the primary channel prediction unit and the secondary channel prediction unit, and transmitting corresponding channel status information (CSI) to the transmitter. By predicting the channel considering the channel time-varying characteristic and performing the adaptive transmission, a target QoS can be maintained in the case where the mobility is about 30 km/h, without loss of the system throughput performance.

### CROSS-REFERENCE TO RELATED APPLICATIONS

### BACKGROUND OF THE INVENTION

Field of the Invention

The present invention relates to a channel prediction apparatus and method of an Orthogonal Frequency Division Multiplexing (OFDM)/Frequency Division Duplex (FDD) system, and more particularly, to a multi-step channel prediction apparatus and method for adaptive transmission in an OFDM/FDD system, which can perform an adaptive transmission by predicting a channel, considering a time-varying characteristic of a channel changing within one slot, as well as a feedback and processing delay time between a transmitter and a receiver.

As interest in the fourth generation (4G) mobile communication is increasing at home and abroad, studies on systems meeting requirements of a 4G mobile communication system have been actively conducted. Specifically, an OFDM scheme is considered to be suitable for the 4G mobile communication system because it has a high transmission efficiency and supports a simple channel equalization scheme.

Due to a frequency selectivity derived from multi-path fading channels, some of subchannels in the OFDM system may have a very low SNR value. Data transmitted over these subchannels exhibit a high error rate, resulting in the degradation of system performance.

To solve this problem, an adaptive transmission scheme is applied to the subchannels of the OFDM system. The adaptive transmission scheme is to apply different modulation and coding level, depending on a channel state.

In order to apply the adaptive transmission scheme to the OFDM system, a transmitter must know a channel state for each user's subchannel. In the case of an FDD system, a transmitter can obtain channel information for each user's subchannel through feedback from each user. In the case of a Time Division Duplex (TDD) system, a transmitter can obtain channel information for each user's subchannel by channel estimation.

Most studies on the adaptive transmission scheme have been conducted on the assumption that the transmitter has accurate channel information of each user. In a real situation, however, due to the transmission and processing delay between the transmitter and the receiver, a real channel having mobility may be significantly different from a channel considered during an adaptive transmission. This results in degradation of an overall system performance.

In order to prevent the channel information from being outdated due to the delay caused by the transmission and processing of the transmitter and the receiver, a channel considered during an adaptive transmission is made to be almost similar to a real channel by combining the channel estimation scheme with the adaptive transmission scheme.

Most channel estimation schemes have been proposed on the assumption that there is no channel change during a predetermined time, e.g., one slot. In this case, the channel estimation scheme can prevent a channel from being outdated due to the feedback and processing delay of the transmitter and the receiver, but cannot prevent the degradation of packet error rate (PER) performance, which is caused by a channel rapidly changing in one slot under a high-speed movement situation.

That is, the conventional adaptive transmission scheme has a drawback in that it cannot satisfy quality of service (QoS) or outage probability desired in a mobile environment. Therefore, instead of the adaptive transmission scheme, a diversity mode operation is proposed in a mobile environment of more than 3 km/h at a center frequency of about 2 GHz. Studies on the use of the channel estimation scheme for the adaptive transmission are in progress in order for the adaptive transmission scheme that can obtain a higher system throughput and satisfy a desired QoS. However, further studies are still necessary.

However, most channel estimation schemes have been proposed on the assumption that there is no channel change during a predetermined time, e.g., one slot. In this case, the channel estimation scheme can prevent a channel from being outdated due to the feedback and processing delay of the transmitter and the receiver, but cannot prevent the degradation of PER performance, which is caused by a channel rapidly changing in one slot under a high-speed movement situation.

### SUMMARY OF THE INVENTION

An advantage of the present invention is that it provides a multi-step channel prediction apparatus and method for adaptive transmission in an OFDM/FDD system. In the multi-step channel prediction apparatus and method, a channel prediction is preformed considering a time-varying characteristic of a channel changing within one slot, in addition to feedback and processing delay time between a transmitter and a receiver, and an adaptive transmission is performed. Therefore, a target PER performance can be maintained without loss of the system performance.

According to an aspect of the present invention, there is provided a multi-step channel prediction apparatus for adaptive transmission in an OFDM/FDD system, the OFDM/FDD system having a channel equalization unit for channel-equalizing a reception baseband OFDM signal which is FFT-converted by an FFT unit, and a channel estimation unit for performing a channel estimation from an output of the FFT unit, the channel prediction apparatus including: a primary channel prediction unit for predicting a channel to be generated before a first OFDM symbol from an output of the channel estimation unit; a secondary channel prediction unit for predicting a channel to be generated before a second OFDM symbol, based on a channel value predicted by the primary channel prediction unit and a measured channel value that is a reception channel value previously checked by a mobile station; and a channel information determination unit for determining if a channel characteristic during one slot period is monotone decreasing or monotone increasing, based on the outputs of the primary channel prediction unit and the secondary channel prediction unit, and transmitting corresponding channel status information (CSI) to the transmitter.

According to another aspect of the present invention, the channel information determination unit determines that the channel characteristic is monotone decreasing, when a channel SNR value provided from the primary channel prediction unit based on the channel prediction value to be generated before the first OFDM symbol is greater than a channel SNR value provided from the secondary channel prediction unit based on the channel prediction value to be generated before the second OFDM symbol; and the channel information determination unit determines that the channel characteristic is monotone increasing, when the channel SNR value provided from the primary channel prediction unit is less than the channel SNR value provided from the secondary channel prediction unit.

According to a further aspect of the present invention, the channel information determination unit transmits the channel SNR value to be generated before the second OFDM symbol as the CSI to the transmitter when the channel characteristic is monotone decreasing, and transmits the channel SNR value to be generated before the first OFDM symbol as the CSI when the channel characteristic is monotone increasing.

According to a further aspect of the present invention, the second OFDM symbol is a 2L^{th} OFDM symbol when the first OFDM symbol is an L^{th} OFDM symbol.

According to a further aspect of the present invention, the CSI is given by:

$${CSI}_{I + L} ( k ) = \{ \begin{matrix}{\hat{p}}_{I + Lp} ( k ) , & when {\hat{p}}_{I + Lp} ( k ) \leq {\hat{p}}_{I + 2 Lp} ( k ) \\ {\hat{p}}_{I + 2 Lp} ( k ) , & when {\hat{p}}_{I + Lp} ( k ) > {\hat{p}}_{I + 2 Lp} ( k )\end{matrix}$$

where \hat{p}_{I+Lμ}(k) is the output of the primary channel prediction unit, which represents a predicted instantaneous channel power of a k^{th} subcarrier, and \hat{p}_{I+2Lμ}(k) is the output of the secondary channel prediction unit, which represents a predicted instantaneous channel power of the k^{th} subcarrier.

According to a further aspect of the present invention, there is provided a multi-step channel prediction method for adaptive transmission in an OFDM/FDD system, the OFDM/FDD system having a channel equalization unit for channel-equalizing a reception baseband OFDM signal which is FFT-converted by an FFT unit, a channel estimation unit for performing a channel estimation from an output of the FFT unit, primary and secondary channel prediction units for performing a channel prediction from an output of the channel estimation unit, and a channel information determination unit for providing CSI to a transmitter, based on outputs of the primary and secondary channel prediction units, the channel prediction method including: at the primary channel prediction unit, predicting a channel to be generated before a first OFDM symbol; at the secondary channel prediction unit, predicting a channel to be generated before a second OFDM symbol, based on a channel value predicted by the primary channel prediction unit and a measured channel value that is a reception channel value previously checked by a mobile station; at the channel information determination unit, determining if a channel characteristic during one slot period is monotone decreasing or monotone increasing, based on the channel estimations of the primary channel prediction unit and the secondary channel prediction unit; and at the channel information determination unit, transmitting a corresponding CSI to the transmitter, based on the determination result of the channel information determination unit.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a transmitter and a receiver in an OFDM adaptive transmission system using a general channel prediction scheme;

FIG. 2 is a graph illustrating a reception SNR variation of a specific subcarrier in a receiver of a general OFDM adaptive transmission system;

FIG. 3 is a block diagram of a multi-step channel prediction apparatus for adaptive transmission in an OFDM/FDD system according to an embodiment of the present invention; and

FIG. 4 is a flowchart illustrating a multi-step channel prediction method for adaptive transmission in an OFDM/FDD system according to an embodiment of the present invention.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

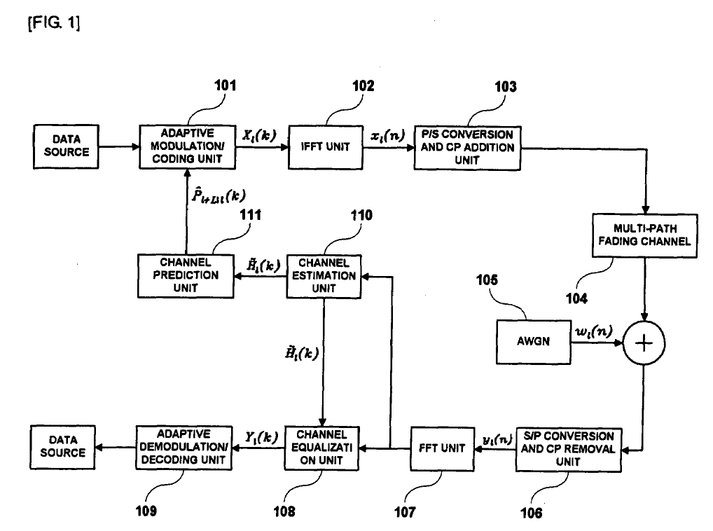

FIG. 1 is a block diagram of an OFDM transmitter and an OFDM receiver, in which a channel prediction unit is included in the receiver. Specifically, an upper side is the transmitter and a lower side is the receiver.

Referring to FIG. 1, the transmitter transmits a data source through an adaptive modulation/coding unit 101, an inverse fast Fourier transform (IFFT) unit 102, and a parallel/serial (P/S) conversion and cyclic prefix (CP) addition unit 103. The P/S conversion and CP addition unit 103 performs a P/S conversion and adds a CP in order to overcome channel fading. The receiver receives the data source which passes through a multi-path fading channel 104 during the transmission operation and to which additive white Gaussian noise (AWGN) 105 is added.

The signal received at the receiver converts serial data into parallel data through an S/P conversion and CP removal unit 106 that performs a reverse operation of the P/S conversion and CP addition unit 103 of the transmitter. The CP added at the transmitter is removed, and an OFDM signal is demodulated through an FFT unit 107. An output of the FFT unit 107 is decoded into the original data through a channel equalization unit 108 and an adaptive demodulation/decoding unit 109.

The output of the FFT unit 107 is provided to the adaptive modulation/coding unit 101 of the transmitter through a channel estimation unit 110 and a channel prediction unit 111, so that the reception state of the receiver can be reflected on the transmitter. In addition, the output of the channel estimation unit 110 is reflected on the channel equalization unit 108 of the receiver.

In such a system, an I^{th} baseband complex OFDM signal can be expressed as Equation (1) below.

$${x}_{I} ( n ) = {\sum }_{k = 0}^{N - 1} {X}_{I} ( k ) {e}^{j2π nk / N} \\ n = 0 , 1 , … , N - 1 \qquad ( 1 )$$

where N represents the number of subcarriers, X_{I}(k) represents an I^{th} frequency-domain baseband complex OFDM signal with respect to a subcarrier k.

A baseband OFDM signal received after the OFDM signal passes through the multi-path fading channel 104 is expressed as Equation (2) below.

$${y}_{I} ( n ) = {\sum }_{k = 0}^{N - 1} {H}_{I} ( k ) {X}_{I} ( k ) {e}^{j2π knIN} + {w}_{I} ( n ) \\ n = 0 , 1 , … , N - 1 \qquad ( 2 )$$

where w_{I}(n) represents an AWGN component experienced by an I^{th} OFDM symbol.

A frequency-domain OFDM symbol can be expressed as Equation (3).

$${Y}_{I} ( k ) = \frac{1}{N} {\sum }_{n = 0}^{N - 1} {y}_{I} ( n ) {e}^{- j2π kn / N} \\ k = 0 , 1 , … , N - 1 \qquad ( 3 )$$

The transmitted signal X_{I}(k) can be obtained by channel equalization of the received signal Y_{I}(k) using a frequency-domain channel value \tilde{H}_{I}(k) experienced by a k^{th} subcarrier of the I^{th} OFDM symbol like Equation (4).

\tilde{X}_{I}(k)=Y_{I}(k)/\tilde{H}_{I}(k) k=0,1, . . . , N−1 (4)

An average SNR value γ̅(k) of the k^{th} subcarrier can be expressed as Equation (5) below.

$$\overline{Y} ( k ) = \overline{H} ( k ) \frac{\overline{S} ( k )}{{σ}_{w}^{2}} \qquad ( 5 )$$

where H̅(k) represents an average channel power at the k^{th} subcarrier, S̅(k)represents an average power transmitted to the k^{th} subcarrier, and σ_{w}² represents an average power of AWGN.

When the average power transmitted to the k^{th} subcarrier is constant, an instantaneous reception power can be expressed as Equation (6) below.

$${Y}_{I} ( k ) = \overline{Y} ( k ) \frac{{r}_{I} ( k )}{\overline{H} ( k )} = {r}_{I} ( k ) \frac{S ( k )}{{σ}_{w}^{2}} \qquad ( 6 )$$

where r_{I}(k) represents an instantaneous channel power of the k^{th} subcarrier of the I^{th} OFDM symbol.

In the FDD system, the receiver must feed back the channel information to the transmitter when the transmitter changes a modulation and coding status (MCS) according to the channel state of the receiver.

The channel information transmitted from the receiver is outdated by the channel information feedback transmission delay and processing delay occurring in the transmitter and the receiver.

In order to solve this problem, the receiver must predict the instantaneous channel SNR value to be experienced after the channel information feedback transmission delay and the processing delay, and transmit the predicted instantaneous channel SNR value to the transmitter. An SNR value γ̅_{I+Lμ}(k) predicted at a subcarrier k of an (I+L)^{th} OFDM symbol can be expressed as Equation (7) below.

$${\hat{Y}}_{I + Lp} ( k ) = \overline{Y} ( k ) \frac{{\hat{p}}_{I + Lp} ( k )}{\overline{H} ( k )} = {\hat{p}}_{I + Lp} ( k ) \frac{\overline{S} ( k )}{{σ}_{w}^{2}} \qquad ( 7 )$$

\hat{p}_{I+Lμ}(k) is an instantaneous channel power predicted at the (I+L)^{th} OFDM symbol of the k^{th} subcarrier. The predicted instantaneous channel power represents a channel value to be experienced by the k^{th} subcarrier after an L^{th} OFDM symbol from a current symbol, and L is a prediction range.

In order to predict the instantaneous channel power, the instantaneous channel value itself must be predicted. The channel value can be predicted using a prediction filter such as a Wiener filter.

A complex channel value of the k^{th} subcarrier after the L^{th} OFDM symbol can be expressed as Equation (8) below using a finite measured instantaneous channel value \tilde{H}_{I}^{H}(k).

Ĥ_{I+Lμ}(k)=\tilde{H}_{I}^{H}(k)c(k) (8)

where c(k) represents a (P×I) vector having P prediction filter coefficients, and \tilde{H}_{I}^{H}(k) is a vector expressed as Equation (9) below.

\tilde{H}_{I}^{H}(k)=[\tilde{H}_{I}(k),\tilde{H}_{I-L}(k), . . . \tilde{H}_{I-L(P-1)}(k)] (9)

H means a Hermitian transpose. The Wiener filter coefficient c(k) is an optimal value in terms of mean square sense (MSE). The complex prediction filter coefficient c(k) can be obtained using Equation (10) below.

c(k)=R_{\tilde{H}}_{_{I}}⁻¹(k)r_{H}_{_{I+L}}_{\tilde{H}}_{_{I}}(k) (10)

R_{\tilde{H}}_{_{I}}(k)=E{\tilde{H}_{I}(k)\tilde{H}_{I}^{H}(k)} (11)

r_{H}_{_{I+L}}_{\tilde{H}}_{_{L}} (k)=E{H_{I+L}(k)\tilde{H}_{I}(k)} (12)

where R_{\tilde{H}}_{_{I}}(k) represents a P×P auto-correlation matrix, and r_{H}_{_{I+L}}_{\tilde{H}}_{_{I}}(k) represents a P×1 cross-correlation matrix with respect to the subcarrier k.

After obtaining the predicted channel value, the instantaneous prediction channel power can be obtained using Equation (13) below.

\hat{P}_{I+Lμ}(k)=c(k)^{H}\tilde{H}_{I}(k)\tilde{H}_{I}^{H}(k)c(k)+ H̅(k)−c(k)^{H}R_{\tilde{H}}_{_{I}}(k)c(k) (13)

Most channel prediction schemes have been proposed on the assumption that there is no channel change during one slot period. However, the mobile environment cannot ignore the channel change during one slot period. In order to prove this, a simple system having a center frequency of 2.3 GHz, an FFT size of 1024, and a system bandwidth of 10 MHz is assumed.

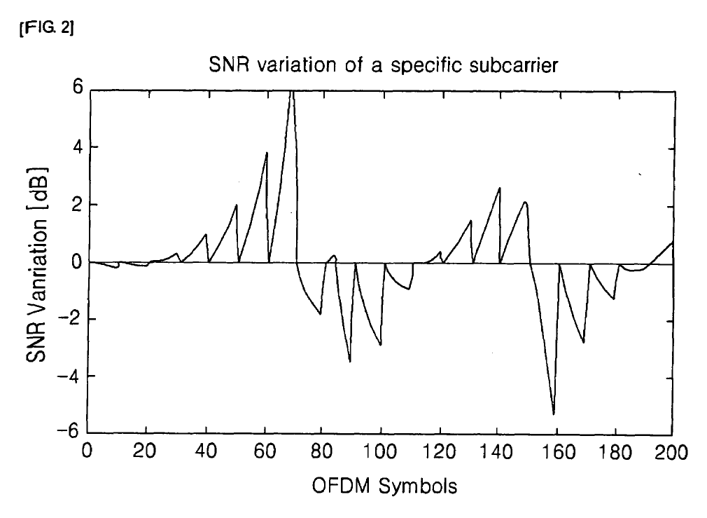

In addition, it is assumed that a time-varying multi-path channel experienced by the OFDM system is ITU-R Veh A 30 km/h. FIG. 2 shows a difference between SNR values at the first OFDM symbol of one slot with respect to a predetermined subcarrier and the remaining OFDM symbols when a length of a slot period where an MCS level changes is 10 OFDM symbols. That is, FIG. 2 shows an SNR variation of a specific subcarrier during one slot period.

As can be seen from FIG. 2, the SNR variation can be significantly great even within one slot. In addition, when the length of the slot period is appropriate, the SNR characteristic of the time-varying channel during one slot period is monotone increasing or monotone decreasing.

An MCS level of a specific subcarrier is determined by an SNR value of a corresponding subcarrier of a first OFDM symbol in the slot. Therefore, an abrupt SNR variation in one slot results in degradation of PER performance in the OFDM/FDD system using an AMC.

When the SNR value of the subcarrier in one slot period is monotone decreasing, an MCS level to be applied to one subcarrier is overestimated, causing the degradation of the PER performance. This factor cannot satisfy a target PER, for example 1%, even though an existing channel prediction scheme is applied.

The present invention proposes a new channel prediction scheme that can cope with a time-varying channel environment. A basic idea of the proposed channel prediction scheme is to use an SNR prediction through two-time channel predictions when determining an MCS level that one subcarrier maintains during one slot.

Most channel prediction schemes perform a channel prediction one time in order to compensate only the transmission and processing delay between the transmitter and the receiver. In order to cope with the abrupt channel variation within one slot, the channel prediction scheme according to the present invention performs the channel prediction one more time so as to determine if the channel size in one slot is monotone increasing or monotone decreasing.

This channel prediction scheme is mathematically expressed as follows. Like the existing channel prediction scheme, the channel prediction scheme according to the present invention uses Equations (8) to (12) to predict a channel Ĥ_{I+Lμ}(k) to be generated before an L^{th} OFDM symbol in order to compensate the transmission and processing delay of the transmitter and the receiver. Then, Equation (13) is used to obtain an instantaneous power \hat{p}_{I+L|I}(k) at a k^{th} subcarrier to be generated before the L^{th} OFDM symbol. In order to consider the channel variation characteristic during one slot period, the channel to be generated before an 2L^{th} OFDM symbol is predicted based on the firstly predicted channel value Ĥ_{I+Lμ}(k) and the existing measured channel values, that is, the reception channel values \tilde{H}_{I}(k), \tilde{H}_{I-L}(k) and \tilde{H}_{I-L(P-2)}(k). which are previously checked by the mobile station. This can be expressed as follows.

Ĥ_{I+2Lμ}(k)=\check{H}_{I}^{H}(k)\check{c}(k) (14)

\check{H}_{I}^{H}(k)=[Ĥ_{I+Lμ}(k), \tilde{H}_{I-L}(k), \tilde{H}_{I-L}(k), . . . , \tilde{H}_{I-L(P-2)}(k)] (15)

\check{c}(k)=R_{\check{H}}_{_{I}}⁻¹(k)r_{H}_{_{I+2L}}_{\check{H}}_{_{I}}(k) (16)

R _{H̅}_{I}(k)=E{\check{H}_{I}(k)\check{H}_{I}^{H}(k)} (17)

r_{H}_{_{I+2L}} ^{H̅}_{_{I}}(k)=E{H_{I+2L}(k)\check{H}_{I}(k)} (18)

In addition, \hat{p}_{I+2Lμ}(k) can be obtained like Equation (19) below, based on Equations (14) to (18).

\hat{p}_{I+2Lμ}(k)=\check{c}(k)^{H}\check{H}_{I}(k)\check{H}_{I}(k)\check{c}(k)+ H̅(k)−\check{c}(k)^{H}R_{\check{H}}_{_{I}}(k)\check{c}(k) (19)

The MCS level is determined based on the two predicted SNR values, that is, \hat{p}_{I+|I}(k) and \hat{p}_{I+2L|I}(k). The channel information used herein is determined like Equation (20) below.

$${CSI}_{I + L} ( k ) = \{ \begin{matrix}{\hat{p}}_{I + Lp} ( k ) , & when {\hat{p}}_{I + Lp} ( k ) \leq {\hat{p}}_{I + 2 Lp} ( k ) \\ {\hat{p}}_{I + 2 Lp} ( k ) , & when {\hat{p}}_{I + Lp} ( k ) > {\hat{p}}_{I + 2 Lp} ( k )\end{matrix} \qquad ( 20 )$$

When the channel SNR value to be generated before the L^{th} OFDM symbol is greater than the channel SNR value to be generated after the 2L^{th} OFDM symbol, the mobile station determines that the channel characteristic during one slot period is monotone decreasing. Therefore, the prediction channel SNR value to be generated before the 2L^{th} OFDM symbol is transmitted as channel status information (CSI). In the opposite case, the prediction channel SNR value to be generated before the L^{th} OFDM symbol is transmitted as the CSI, thereby preventing the channel from being overestimated.

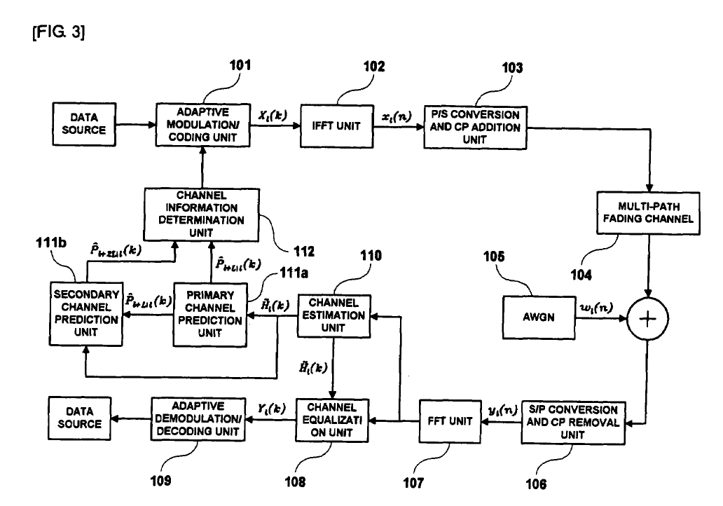

FIG. 3 is a block diagram of a system for implementing a channel prediction according to an embodiment of the present invention. Referring to FIG. 3, instead of the channel prediction unit 111 of FIG. 1, a primary channel prediction unit 111a and a secondary prediction unit 111b are included to perform the channel prediction two times. In addition, a channel information determination unit 112 is further included to provide CSI to a transmitter, based on the channel predictions of the primary channel prediction unit 111a and the secondary channel prediction unit 111b.

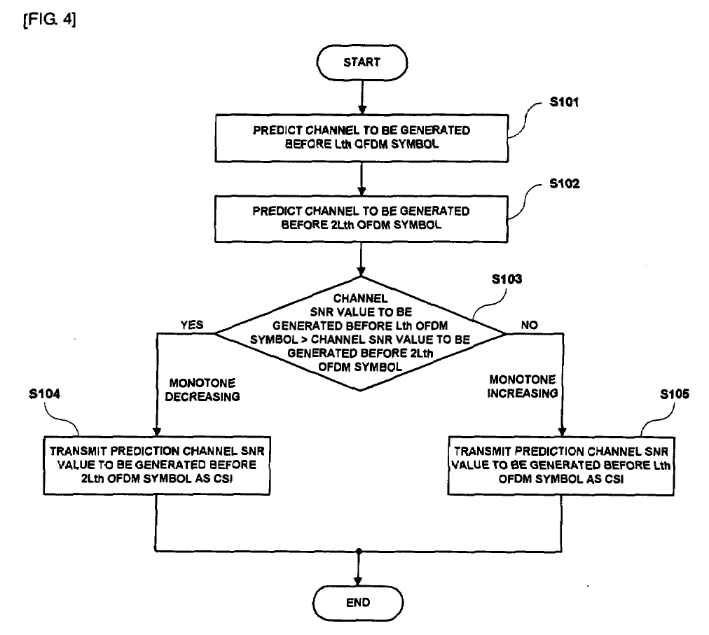

An operation of the system according to the present invention will be described below with reference to FIG. 4.

In step S101, like the channel prediction unit 111 of FIG. 1, the primary channel prediction unit 111a uses Equations (8) to (13) to predict the channel to be generated before the L^{th} OFDM symbol in order to compensate the transmission and processing delay of the transmitter and the receiver. In step S102, based on the channel value predicted by the primary channel prediction unit 111a and the existing measured channel value (that is, the reception channel value checked by the mobile station), the secondary channel prediction unit 111b predicts the channel to be generated before the 2L^{th} OFDM symbol, considering the channel variation characteristic during one slot period. This is given as Equations (14) and (15).

In addition, based on the channel prediction values, the primary channel prediction unit 111a and the secondary channel prediction unit 111b obtain the channel SNR values from Equations (13) and (19). Based on these values, the channel information determination unit 112 determines the CSI used to determine the MCS level at the adaptive modulation/coding unit 101 of the transmitter, like in Equation (20).

That is, in steps S103 to Si 05, when the channel SNR value to be generated before the L^{th} OFDM symbol is greater than the channel SNR value to be generated before the 2L^{th} OFDM symbol, the mobile station determines that the channel characteristic during one slot period is monotone decreasing. Thus, the channel information determination unit 112 transmits the prediction channel SNR value to be generated before the 2L^{th} OFDM symbol as the CSI. In the opposite case, the channel information determination unit 112 transmits the prediction channel SNR value to be generated before the L^{th} OFDM symbol as the CSI, thereby preventing the channel from being overestimated.

Because a subband having a plurality of consecutive subcarriers is allocated to the mobile stations as an allocation unit, each mobile station must apply the above-described procedures, based on the average value of the prediction reception power per the subcarrier of the subband.

As described above, the L^{th} OFDM symbol is predicted in order to compensate the feedback and processing delay time such that the channel time-varying characteristic within one slot can be considered, in addition to the feedback and processing delay time between the transmitter and the receiver. In order to consider the characteristic of the channel changing within the slot, the 2L^{th} OFDM symbol is predicted using the predicted channel value and several measured channel values, and the adaptive transmission is then performed. Therefore, in the case where the mobility is about 30 km/h, the target QoS can be maintained without loss of the system throughput performance.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A multi-step channel prediction apparatus for adaptive transmission in an OFDM/FDD system, the OFDM/FDD system having a channel equalization unit for channel-equalizing a reception baseband OFDM signal which is FFT-converted by an FFT unit, and a channel estimation unit for performing a channel estimation from an output of the FFT unit, the channel prediction apparatus comprising:
a primary channel prediction unit for predicting a channel to be generated before a first OFDM symbol from an output of the channel estimation unit;
a secondary channel prediction unit for predicting a channel to be generated before a second OFDM symbol, based on a channel value predicted by the primary channel prediction unit and a measured channel value that is a reception channel value previously checked by a mobile station; and
a channel information determination unit for determining if a channel characteristic during one slot period is monotone decreasing or monotone increasing, based on the outputs of the primary channel prediction unit and the secondary channel prediction unit, and transmitting corresponding channel status information (CSI) to the transmitter.

2. The multi-step channel prediction apparatus according to claim 1,
wherein the channel information determination unit determines that the channel characteristic is monotone decreasing, when a channel SNR value provided from the primary channel prediction unit based on the channel prediction value to be generated before the first OFDM symbol is greater than a channel SNR value provided from the secondary channel prediction unit based on the channel prediction value to be generated before the second OFDM symbol; and the channel information determination unit determines that the channel characteristic is monotone increasing, when the channel SNR value provided from the primary channel prediction unit is less than the channel SNR value provided from the secondary channel prediction unit.

3. The multi-step channel prediction apparatus according to claim 2,
wherein the channel information determination unit transmits the channel SNR value to be generated before the second OFDM symbol as the CSI to the transmitter when the channel characteristic is monotone decreasing, and transmits the channel SNR value to be generated before the first OFDM symbol as the CSI when the channel characteristic is monotone increasing.

4. The multi-step channel prediction apparatus according to claim 1,
wherein the second OFDM symbol is a 2L^{th} OFDM symbol when the first OFDM symbol is an L^{th} OFDM symbol.

5. The multi-step channel prediction apparatus according to claim 1,
wherein the CSI is given by:
$${CSI}_{I + L} ( k ) = \{ \begin{matrix}{\hat{p}}_{I + Lp} ( k ) , & when {\hat{p}}_{I + Lp} ( k ) \leq {\hat{p}}_{I + 2 Lp} ( k ) \\ {\hat{p}}_{I + 2 Lp} ( k ) , & when {\hat{p}}_{I + Lp} ( k ) > {\hat{p}}_{I + 2 Lp} ( k )\end{matrix}$$
where \hat{p}_{I+Lμ}(k) is the output of the primary channel prediction unit, which represents a predicted instantaneous channel power of a k^{th} subcarrier, and \hat{p}_{I+2Lμ}(k) is the output of the secondary channel prediction unit, which represents a predicted instantaneous channel power of the k^{th} subcarrier.

6. A multi-step channel prediction method for adaptive transmission in an OFDM/FDD system, the OFDM/FDD system having a channel equalization unit for channel-equalizing a reception baseband OFDM signal which is FFT-converted by an FFT unit, a channel estimation unit for performing a channel estimation from an output of the FFT unit, primary and secondary channel prediction units for performing a channel prediction from an output of the channel estimation unit, and a channel information determination unit for providing CSI to a transmitter, based on outputs of the primary and secondary channel prediction units, the channel prediction method comprising:
at the primary channel prediction unit, predicting a channel to be generated before a first OFDM symbol;
at the secondary channel prediction unit, predicting a channel to be generated before a second OFDM symbol, based on a channel value predicted by the primary channel prediction unit and a measured channel value that is a reception channel value previously checked by a mobile station;
at the channel information determination unit, determining if a channel characteristic during one slot period is monotone decreasing or monotone increasing, based on the channel estimations of the primary channel prediction unit and the secondary channel prediction unit; and
at the channel information determination unit, transmitting corresponding CSI to the transmitter, based on the determination result of the channel information determination unit.

7. The multi-step channel prediction method according to claim 6,
wherein a channel SNR value to be generated before the second OFDM symbol is provided as the CSI when it is determined that the channel characteristic is monotone decreasing.

8. The multi-step channel prediction method according to claim 6,
wherein a channel SNR value to be generated before the first OFDM symbol is provided as the CSI when it is determined that the channel characteristic is monotone increasing.

9. The multi-step channel prediction method according to claim 6,
wherein the second OFDM symbol is a 2L^{th} OFDM symbol when the first OFDM symbol is an L^{th} OFDM symbol.

10. The multi-step channel prediction method according to claim 6,
wherein the CSI is given by:
$${CSI}_{I + L} ( k ) = \{ \begin{matrix}{\hat{p}}_{I + Lp} ( k ) , & when {\hat{p}}_{I + Lp} ( k ) \leq {\hat{p}}_{I + 2 Lp} ( k ) \\ {\hat{p}}_{I + 2 Lp} ( k ) , & when {\hat{p}}_{I + Lp} ( k ) > {\hat{p}}_{I + 2 Lp} ( k )\end{matrix}$$
where \hat{p}_{I+L|I}(k) is the output of the primary channel prediction unit, which represents a predicted instantaneous channel power of a k^{th} subcarrier, and \hat{p}_{I+2Lμ}(k) is the output of the secondary channel prediction unit, which represents a predicted instantaneous channel power of the k^{th} subcarrier.
